(19) United States
(12) Patent Application Publication
(10) Pub. No.: US 2024/0280192 A1
(43) Pub. Date: Aug. 22, 2024

(54) CONDUIT SEAL ASSEMBLY

(71) Applicant: Peak Plastics, LLC, Constantine, MI (US)

(72) Inventor: Matthew A. Thompson, White Pigeon, MI (US)

(21) Appl. No.: 18/436,689

(22) Filed: Feb. 8, 2024

Related U.S. Application Data
(60) Provisional application No. 63/446,473, filed on Feb. 17, 2023.

(51) Int. Cl. F16L 5/10

(52) U.S. Cl. CPC F16L 5/10

(57) ABSTRACT

A conduit seal assembly for a wall opening in a wall includes a seal with an annular body. The annular body has a first end and a second opposed end, with the first end forming a conduit receiving end, and the second opposed end forming a seal insertion end. The seal insertion end has an outer diameter sized approximately equal to the wall opening in the wall into which the seal is to be inserted. The annular body further includes an outer lip between the conduit receiving end and the seal insertion end and additionally includes a tapered inner diameter that tapers to a smaller diameter at the seal insertion end so that when a conduit is inserted into the seal the conduit will cause the seal insertion end to expand to trap the seal in the wall at the wall opening.

### CROSS REFERENCE TO RELATED APPLICATION

The present application claims the benefit of U.S. Prov. Appl. Ser. No. 63/446,473, filed on Feb. 17, 2023, which is incorporated by reference herein in its entirety.

### TECHNICAL FIELD AND BACKGROUND

This present disclosure relates generally to a conduit seal assembly, and particularly to a conduit seal assembly that encircles a conduit, such as tubing or a pipe, that is inserted into a wall, such as the wall of a container or the wall of another conduit.

In U.S. Pat. No. 5,029,879 ('879 patent) a seal is described for sealing pipes in a wall opening in a wall. The seal has an annular body with a first outer lip 12 on one end and a second outer lip 28 at its second opposed end (or insertion end), which is inserted through the opening in the wall. The annular body has an inner diameter that is tapered so that when the pipe is inserted into the seal (after the seal has been inserted into the opening in the wall), the pipe causes the insertion end to expand, trapping the seal in the wall between its first lip and its expanded insertion end.

While the seal in the '879 patent improves the seal of the pipe in the wall over previous seals, it has been found that the pipe may be inadvertently inserted too far into the seal, possibly effecting the installation.

Accordingly, the present disclosure provides a seal assembly that prevents a conduit from being inserted too far into an annular seal and, thus, better controls the installation process.

### SUMMARY

Accordingly, the present disclosure describes a stop that is interposed between a conduit and the seal, which prevents the conduit from being inserted too far into the seal.

In one form, a conduit seal assembly for sealing a conduit in a wall opening of a wall includes a seal with an annular body. The annular body has a first end that forms a conduit receiving end and a second opposed end that forms a seal insertion end. The seal insertion end has an outer diameter that is sized approximately equal to the wall opening in the wall into which the seal is to be inserted. The annular body further includes an outer lip between the conduit receiving end and the seal insertion end. The annular body additionally includes a tapered inner diameter that tapers to a smaller diameter at the seal insertion end so that when a conduit is inserted into the seal, after the seal is fully inserted into the wall opening, the conduit will cause the seal insertion end to expand to trap the seal in the wall at the wall opening. The conduit seal assembly further includes a stop that prevents the conduit from being inserted into the seal beyond a predetermined depth in the seal.

In one aspect, the stop may be formed by an insert that is interposed between the seal and the conduit. For example, the insert may be formed from an annular body with an outwardly extending lip that forms an outer stop against the conduit receiving end of the seal. The annular body of the insert further includes an inner stop to prevent the conduit from extending beyond a predetermined depth into the insert. In this manner, when the conduit is inserted into the insert, the inner stop will prevent over-insertion of the conduit into the insert. When the insert and the conduit are then inserted into the seal (after the seal has been inserted in to the wall opening), the insert and conduit will cause the seal insertion end of the seal to expand while the conduit is stopped at the predetermined insertion depth in the insert, and the insert is stopped at the predetermined insertion depth in the seal. Thus, both the conduit and the insert are stopped at the predetermined insertion depth in the seal.

In another aspect, the insert includes a conduit receiving end and an insert insertion end for inserting into the seal. The insert insertion end has a lip that when fully inserted into the seal forms a stop to trap the insert in the seal when the insert and conduit are fully inserted into the seal.

In any of the above, the seal is formed from a rubber material.

In any of the above, the insert may be formed from plastic or another rigid material, including metal.

According to another form, a method of sealing a conduit in a wall opening in a wall includes using a seal with an annular body. The annular body has an outer stop for stopping the annular body from fully passing through the wall at the wall opening. The annular body also includes a tapered inner diameter so that when a conduit is inserted into the seal (after the seal is inserted into the wall opening) the insertion end of the seal expands to trap the seal in the wall at the wall opening between the outer stop and the expanded insertion end. The method further includes providing a stop to prevent the conduit from being inserted into the seal beyond a predetermined depth in the seal.

In one aspect, the method includes forming an insert with an outer stop. The conduit is inserted into the insert followed by inserting both the insert and the conduit into the seal, with the outer stop of the insert preventing the insert and conduit from being inserted into the seal beyond a predetermined depth in the seal.

In yet a further aspect, the method includes forming the insert with an inner stop. The step of inserting the conduit includes inserting the conduit into the insert up to the inner stop, and then inserting both the insert and the conduit into the seal. The inner stop then prevents the conduit from being inserted into the insert beyond a predetermined depth in the insert, while the outer stop prevents the insert and conduit from being inserted into the seal beyond a predetermined depth in the seal.

### BRIEF DESCRIPTION OF THE DRAWINGS

Further characteristics and advantages of the invention will become more readily apparent from the following detailed description of a preferred embodiment of the invention, illustrated by way of example in the accompanying drawings in which:

FIG. 1 is a perspective view of a pipe seal embodying the present invention and positioned adjacent a wall opening into which it will be inserted;

FIG. 1A is an exploded cross-sectional view taken along line 1A-1A of FIG. 1;

FIG. 2 is a similar view to FIG. 1A illustrating the conduit inserted in to the insert and the seal inserted into the wall opening; and

FIG. 3 is a cross-sectional view similar to FIG. 1A but in an assembled configuration illustrating the expansion of the insertion end of the seal when it is assembled in a wall with the insert and conduit fully inserted into the seal.

### DETAILED DESCRIPTION

Although described and illustrated in the context of an opening in a wall and insertion into a flat wall, the conduit seal assembly described herein can also be applied to a non-flat wall, including a cylindrical wall, such as a pipe wall or a tank wall. Accordingly, the illustrations are not intended to be, nor should they be construed to be, a limitation on the disclosure.

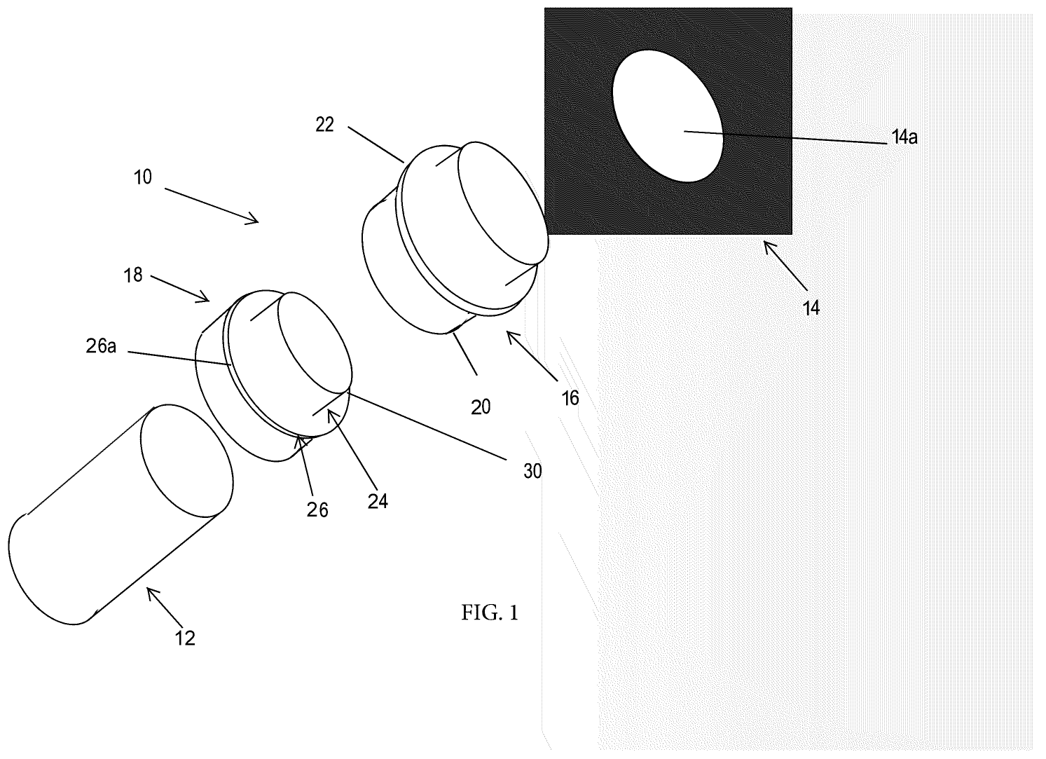

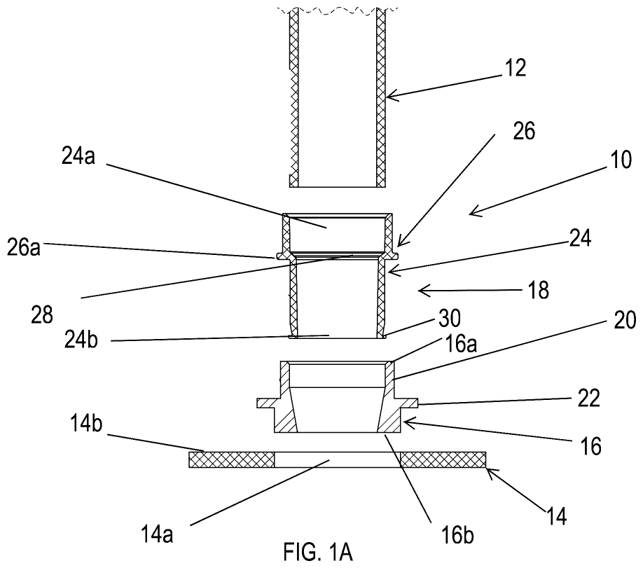

Referring to FIGS. 1 and 1A, the numeral 10 generally designates a seal assembly for a conduit 12, such a pipe or tubing. As will be more fully described below, seal assembly 10 is configured to seal the conduit 12 in a wall opening 14a of a wall 14, as well as control the insertion of the conduit into the seal assembly to avoid over insertion of the conduit.

Referring again to FIG. 1A, seal assembly 10 includes a seal 16 and an insert 18, which forms a stop for the conduit as described below. Seal 16 is configured to seal the conduit 12 in the opening 14a of wall 14 and, further, to mechanically engage the wall 14 once fully inserted into the opening 14a and once the conduit and insert are fully inserted into the seal 16 at conduit receiving end 16a of seal 16.

As best illustrated in FIGS. 1 and 1A, seal 16 includes an annular body 20 with an outer annular lip 22 that forms a stop for stopping the annular body 20 from fully passing through the wall 14 at the wall opening 14a and for sealing against the first side 14b of wall 14. Annular body 20 has a tapered inner diameter, for example, which taper starts inwardly at or inwardly adjacent the outer annular lip (but on the inside surface of the annular body) and extends through to the opposed seal insertion end 16b of seal. Optionally, the conduit receiving end 16a of seal 16 has a smaller outer diameter than the seal insertion end 16b of seal 16 so that annular body 20 has a stepped exterior profile, with the lip 22 located at and projecting radially outward from the step formed by the transition between the two outer diameters. To form a sealing function, seal 16 is formed from a resilient, elastic material, such as elastomeric material, including a rubber material, so that it can provide several sealing surfaces against wall 14 and, further, be frictionally held in opening 14a using a friction fit. Additionally, the elastic material allows the seal to expand, as described below, and also conform to a non-planar surface.

As best seen in FIG. 1A, insert 18, which may be made from a rigid material, such as plastic, is also formed from an annular body 24, which includes a conduit receiving end 24a, for receiving conduit 12, and an insertion end 24b for insertion into seal 16. The inner diameter of conduit receiving end 24a of insert 18 is sized so that it forms a friction fit with conduit 12 and therefore, forms a seal with conduit 12. Annular body 24 may have a stepped profile where conduit receiving end 24a has a larger outer diameter than insertion end 24b, and further with the stepped profile forming an annular external stop 26 and an annular internal stop 28 at the step or transition formed by the step profile. The annular external stop 26 is provided to prevent insertion of the insert (and hence conduit inserted therein) from being inserted into seal 16 beyond a maximum desired insertion depth. Internal stop 28 similarly prevents the insertion of the conduit 12 from being inserted into insert 18 beyond a maximum desired insertion depth in insert 18. Thus, when fully assembled, both stops 26 and 28 prevent the conduit 12 from being inserted beyond a maximum desired insertion depth in seal assembly 10.

Optionally, external stop 26 may be increased in diameter by an outwardly extending annular lip 26a. Optionally, lip 26a may be formed by a plurality of lip segments or may be a continuous annular lip, so while the step may form a continuous annular stop, the lip may be segmented. Additionally, although annular body 24 is illustrated as a monolithic body formed, for example, from molding plastic, lip 26a may be formed on annular body 24 from another material and post-formed or co-formed, such as in a co-injection molding process or the like.

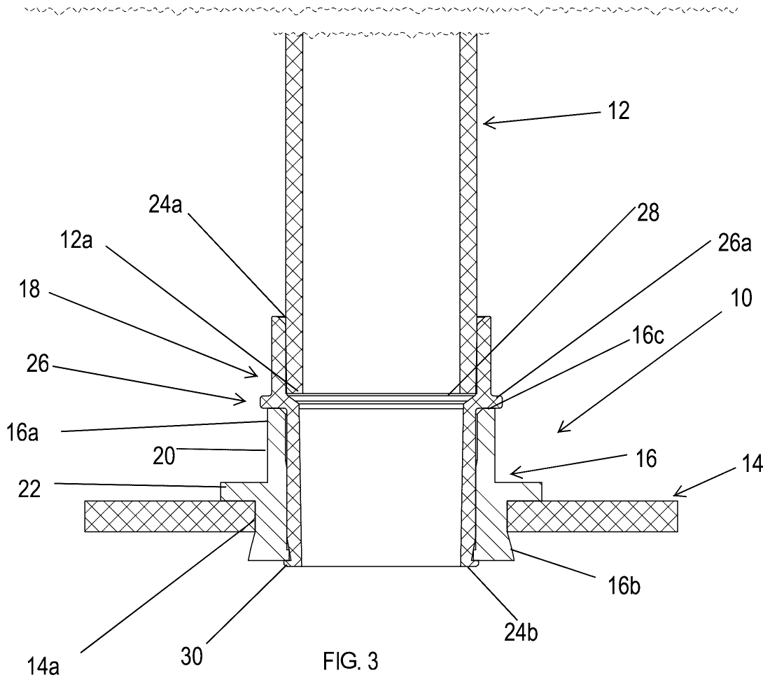

Optionally the insertion end 24a of insert 18 may also include an annular lip 30 to form yet another stop. As best seen in FIG. 3, when insert 18 is fully inserted into seal 16, lip 30 passes though insertion end 16b of seal 16, with insertion end 16b rebounding inwardly (due to its elastic properties) to a diameter less than the outer diameter of lip 30 so that lip 30 then traps insert 18 in seal 16 between external stop 26 and lip 30.

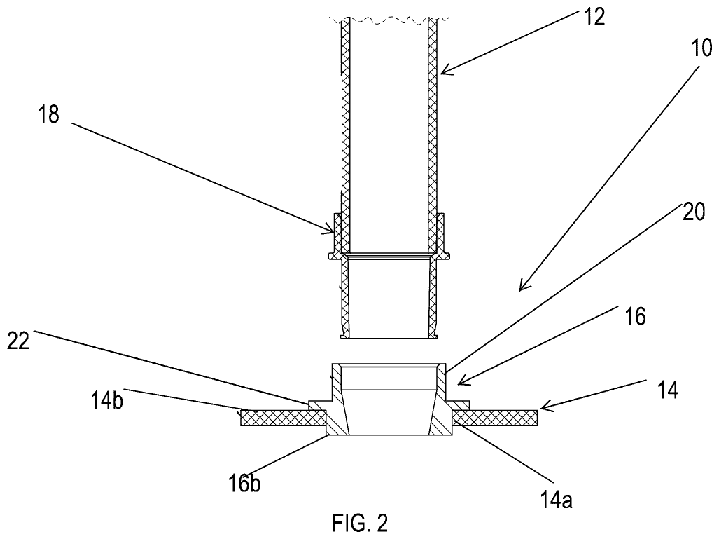

As best understood from FIG. 2, the outer diameter of the seal insertion end 16b of seal 16 is sized so that when seal 16 is inserted into the wall opening 14a, seal 16 is sealed in opening, for example, by a friction fit and, therefore, is frictionally held therein and forms a seal in the wall. Further, as noted above, when fully inserted into opening 14a, lip 22 seals against and acts as a stop against side 14b of wall 14. As will more fully described below, when seal 16 is fully inserted into wall opening 14a, and conduit 12 and insert 18 are fully inserted into seal 16, seal 16 will be trapped in opening 14a between lip 22 and the enlarged insertion end 16b of seal 16, described more fully below.

As noted above, the inside diameter of annular body 20 of seal 16 is tapered so that the inside diameter at the conduit receiving end 16a is larger than the inner diameter at the seal insertion end 16b. Thus, the wall thickness of the portion of the annular body above lip 22 may be thinner than the wall thickness of the portion of the annular body 20 below lip 22, as viewed in FIGS. 1, 1A, 2, and 3. It should be understood that the terms above and below as used herein are for reference only. Further, the inner diameter of conduit receiving end 16a of seal 16 is approximately equal to the outer diameter of insert 18 so that when conduit 12 and insert 18 are inserted into the seal 16 (after the seal is inserted into the wall opening), the further insertion of the insert 18 and conduit 12 into seal 16 will cause insertion end 16b of the seal 16 to expand to trap the seal 16 in the wall 14 at the wall opening 14a between the outer lip 22 and the expanded insertion end 16b.

For example, the inside diameter at conduit insertion end 16a of seal 16 may be sized so that it is slightly greater than the outer diameter of insert 18 merely to facilitate insertion. Optionally the conduit insertion end 16a may have a taper 16c to ease insertion of the insert 18 but then have straight or parallel sides (which have an inner diameter approximately equal to the outer diameter of insert 18) until reaching the tapered portion of the inside of seal 16. Optionally, the inner diameter of seal 16 may be tapered in sections, with each section having a different taper with a different angle. The axial length of straight portion of the inner diameter of seal 16 may terminate above the lip 22 so that when insert 18 is inserted into seal 16, the seal 16 will be forced to expand radially outward in the opening 14a of wall 14 and, therefore, form a tight seal between seal 16 and wall 14. Thus, when the conduit is fully inserted into the insert, and the insert and conduit are fully inserted into the seal, the seal forms a plurality of sealing surfaces against the wall around or in the wall opening.

It should be understood that seal 16 may be fabricated of any resilient material with elastic properties commonly used for the intended purpose. Seal 16 may be molded of a semi-elastic, semi-plastic rubber-like composition, which possesses a certain degree of rigidity, but which is stretchable and pliable—and elastic.

In operation, as illustrated in FIGS. 2 and 3, seal 16 is inserted in wall opening 14a in wall 14 until lip 22 abuts side 14b of wall 14. Referring again to FIGS. 2 and 3, after conduit 12 has been fully inserted into insert 18 (where the terminal end 12a of conduit 12 is now resting on and abutting internal stop 28), insert 18 and conduit 12 are inserted into seal 16 until external stop 26 abuts the upper edge 16c of conduit insertion end 16 of seal 16. As the insert 18 is inserted into seal 16, insertion end 24b of insert 18 will cause seal 16 to expand in opening 14a and will also cause insertion end 16b of seal to expand, trapping the seal 16 in opening 14a. As noted above, when insert 18 and conduit 12 are fully inserted into seal 16, lip 30 will trap insert 18 in seal 16. As a result, insert 18 and conduit 12 are tightly grasped by seal 16 to such an extent that the insert 18 and conduit 12 cannot easily be removed from the wall. Further, this prevents the conduit 12 from wobbling and ensures that it will not become loosened due to vibrations or the like.

It should be understood that the diameter of the seals and inserts may be varied to accommodate different installations. Hence, nothing herein should be construed as a size limitation.

While the preferred embodiment of this invention has been illustrated and described, it will be understood that changes in the structures may be made within the scope of the appended claims without departing from the spirit of the disclosure.

1. A fluid conduit seal assembly for a fluid conduit in a wall, the wall having a first sides, a second side, and a wall opening extend from the first side to the second side, said conduit seal assembly comprising:
an elastic seal with a solid annular body, the solid annular body having a first end and a second opposed end, the first end forming a conduit receiving end, the second opposed end forming a seal insertion end for inserting into the wall opening from the first side of the wall, the seal insertion end having a continuous outer cylindrical surface with an outer perimeter, the outer perimeter having a diameter sized approximately equal to the wall opening in the wall into which the seal is to be inserted from the first side of the wall, and the annular body further including an outer lip extending radially outward from a medial portion of the annular body between the conduit receiving end and the seal insertion end to sealing engage the first side of the wall, the annular body including a tapered inner diameter that tapers to a smaller diameter at the seal insertion end so that when a fluid conduit is inserted into the elastic seal, after the elastic seal is fully inserted into the wall opening from the first side of the wall, the conduit will press against and form a seal with the tapered inner diameter of the elastic seal and will compress the continuous outer cylindrical surface into contact with the wall opening and will enlarge the insertion end and, further, cause a portion of the insertion end extending beyond the second side of the wall to form a flange to further trap the seal in the wall opening and thereby create a plurality of sealing surfaces against the first side and the second side of the wall and in the wall opening; and
a stop to prevent the conduit from being inserted into the seal beyond a predetermined depth in the seal.

2. The conduit seal assembly according to claim 1, further comprising an insert interposed between the seal and the conduit, and the insert forming the stop.

3. The conduit seal assembly according to claim 2, wherein the insert comprises an annular body with an outwardly extending lip, the outwardly extending lip forming an external stop, and said external stop bearing on said seal insertion end of said elastomeric seal.

4. The conduit seal assembly according to claim 3, wherein the annular body includes an inner stop to prevent the conduit from extending beyond a predetermined depth into the insert.

5. (canceled)

6. The conduit seal assembly according to claim 4, wherein the insert includes a conduit receiving end and an insert insertion end for inserting into the seal, with the insert insertion end having a lip that when full inserted into the seal forms a stop to trap the insert in the seal when the insert and conduit are fully inserted into the seal.

7. The conduit seal assembly according to claim 1, wherein the seal is formed from a rubber.

8. The conduit seal assembly according claim 1, wherein the insert is formed from plastic or another rigid material, including metal.

9. A method of sealing a fluid conduit in a wall opening in a wall using the conduit seal assembly of claim 1.

10. The method according to claim 9, further comprising forming an insert with an outer stop, and inserting the conduit into the insert and then inserting both the insert and the conduit into the seal, with the outer stop preventing the insert and conduit from being inserted into the seal beyond a predetermined depth in the seal.

11. The method according to claim 10, the method further including forming the insert with an inner stop, with the step of inserting the conduit includes inserting the conduit into the insert up to the inner stop and then inserting both the insert and the conduit into the seal, with the inner stop preventing the conduit from being inserted into the insert beyond a predetermined depth in the insert, and the outer stop preventing the insert and conduit from being inserted into the seal beyond a predetermined depth in the seal.

12. The conduit seal assembly according to claim 1, wherein the outer lip comprises an annular outer lip.

13. The conduit seal assembly according to claim 1, wherein the tapered inner diameter starts at or starts adjacent the outer lip but on the inside of the annular body.

14. The conduit seal assembly according to claim 1, wherein the tapered inner diameter starts at a location between the conduit receiving end and the outer lip but on the inside of the annular body and tapers to the seal insertion end of the annular body.

15. The conduit seal assembly according to claim 1, wherein the seal insertion end includes a distal outer diameter that is sized to fill the wall opening but not exceed the wall opening diameter until the insert is inserted into the seal.

16. An insert for use with a fluid conduit seal assembly according to claim 1, said insert comprising:
an annular body, the annular body having an insertion axis and having an external stop, an internal stop, a first end, and a second opposed end spaced from the first end along the insertion axis, the first end forming a conduit receiving end to receive a conduit therein up to the internal stop, the second opposed end forming an insertion end to insert into the conduit insertion end of the seal up to the external stop, the insertion end having a radially outwardly extending lip to expand the seal outwardly when the insert is inserted into the seal after the seal has been inserted into the wall opening to thereby trap the seal in the wall opening.

17. The insert according to claim 16, wherein the annular body has a length to locate the inner stop above the seal wherein a conduit inserted into the insert does not extend into the wall opening.

18. The insert according to claim 17, wherein the inner stop is located along the insertion axis before the external stop to prevent the conduit from extending into the insert beyond the external stop.

19. The insert according to claim 17, wherein the annular body has a uniform inner diameter between the conduit receiving end and the inner stop.
